(19) United States
(12) Patent Application Publication
(10) Pub. No.: US 2005/0169278 A1
(43) Pub. Date: Aug. 4, 2005

(54) Atm traffic generator with interleave memory

(75) Inventors: Kathryn E. Rickard, Romsey (GB); William M. Dries, Southhampton (GB); Paul C. MIllard, Eastleigh (GB)

Correspondence Address: PILLSBURY WINTHROP SHAW PITTMAN, LLP, P.O. BOX 10500, MCLEAN, VA, 22102, US

(73) Assignee: Xyratex Technology Limited, Hampshire (GB)

(21) Appl. No.: 10/509,614

(22) PCT Filed: Apr. 4, 2003
(86) PCT No.: PCT/GB03/01500

Related U.S. Application Data
(60) Provisional application No. 60/371,688, filed on Apr. 12, 2002.

(51) Int. Cl. H04L 12/28

(52) U.S. Cl. 370/395.1

(57) ABSTRACT

A traffic generator for generating a packet information stream that includes plural information cells has plural memory regions. Each memory region contains identical data in the form of plural information cells. A memory-reading device reads information cells from the plural memory regions in an alternating manner such that, as an information cell is being read from one of the memory regions, the next memory region from which the next information cell is to be read can be activated. In this way, the next information cell can be read from the next memory region substantially as soon as the previous information cell has been read from the first memory region, thereby to generate a packet information stream from the read information cells.

The present invention relates to a traffic generator, a method of generating a packet information stream, and a method of providing random access to stored data.

The present invention has particular applicability to the field of ATM network analysis.

As is well known, data packets can be transmitted in the form of discrete information cells over a transmission link. Those information cells can be interleaved on the link with information cells that relate to other data packets, which may be from the same or a different source to the first data packet. The data transmitted may be voice, video or any other type of data.

One network technology that uses such information cells is ATM (Asynchronous Transfer Mode), which is a cell-switched technology in wide use over the present cabled backbone technology. Each frame or data packet to be transmitted is typically split into plural cells, each being a fixed sized unit of 53 bytes. 48 bytes of the ATM cell is used to carry the data itself. The remaining 5 bytes are used as a header. The transmission links are typically shared between many users, with cells from the plural sources being interleaved on each link. The advantages of ATM in particular include increased efficiency of data transmission and speed of data transmission, Moreover, ATM provides a means of guaranteeing a certain transmission capacity to certain users and to do so on-demand. Thus, some users (or other connections) can have more bandwidth allocated than others on the same transmission system. This is known as “traffic shaping”.

In order for network operators to be able to ensure that the networks operate properly, it is necessary to simulate real ATM traffic conditions. Thus, traffic generators are provided which can support plural packets or frames on plural connections, with traffic shaping determined by connection. A number of such traffic generators are already available. U.S. Pat. No. 5,450,400 discloses a traffic generator in which a generation memory is used to store a series of individual data which is cyclically read.

ATM networks use the concept of virtual circuits. A single physical transmission link is subdivided into virtual paths (VP), which are further subdivided into virtual channels (VC). Presently, typical ATM networks allow a physical transmission link to be subdivided into a maximum of 4096 virtual paths, and each virtual path may be further subdivided into a maximum of 65,536 virtual circuits. In order to make the traffic generated by the traffic generator sufficiently realistic, with many different frames on each of the connections, the traffic generator has a large transmit buffer memory in which data relating to the individual cells can be stored and quickly read out to provide a packet information stream. The generation of the data is typically carried out off-line because it is simply not possible to generate the required volumes of data at the required rates “on the fly”.

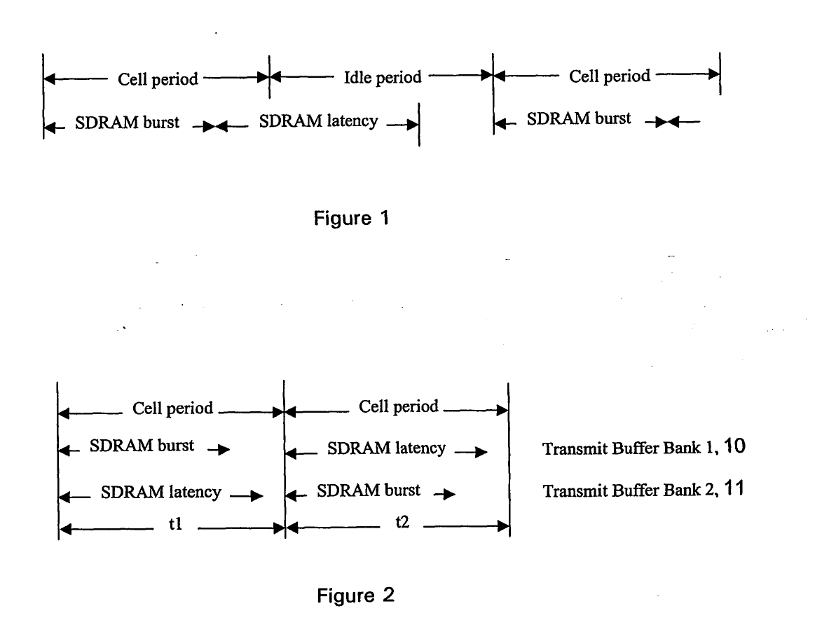

In order to allow a traffic generator to provide full-line rate traffic generation with the full flexibility of dynamic traffic shaping which is required in order for the traffic generator to generate sufficiently realistic traffic, it is necessary to access the data stored in the buffer in a random manner rather than a cyclical manner (as is used in for example the traffic generator of U.S. Pat. No. 5,450,400). However, depending on the type of memory device used for the transmit buffer, there may be a delay between random accesses to the data stored in the memory device, which can severely reduce the rate at which data can be read from the memory device when being read in a random manner. Whilst an SDRAM (Synchronous Dynamic Random Access Memory) is presently the best choice of memory device for the transmit buffer as it provides a cost-effective solution, SDRAMs nevertheless have a significant drawback in this context. In particular, whilst SDRAMs can achieve high bandwidth access when used in a sequential burst access mode and whilst data can be read from the SDRAM on each clock cycle for the full length of a full page, the random access requirement of dynamic traffic-shaping referred to above significantly lowers the bandwidth available from the SDRAM. This is because there is a latency between random accesses of data from an SDRAM whilst a memory bank is being recharged and the next row in the SDRAM is activated. As indicated in FIG. 1 of the accompanying drawings, this can mean that the traffic generator has to insert idle periods between cells in the output packet information stream. As can therefore clearly be seen from FIG. 1, in such a case full-line rate cannot be achieved.

According to a first aspect of the present invention, there is provided a method of generating a packet information stream that comprises plural information cells, the method comprising: storing identical data in the form of plural information cells in each of plural memory regions; and, generating a packet information stream by reading information cells from the plural memory regions in an alternating manner such that, as an information cell is being read from one of the memory regions, the next memory region from which the next information cell is to be read can be activated whereby said next information cell can be read from said next memory region substantially as soon as the previous information cell has been read from said one of the memory regions.

In this manner, the packet information stream can consist of a substantially continuous stream of information cells with practically or literally no delay between the individual cells. This allows for a faster rate of output data in the packet information stream, or use of a slower clock speed for reading the plural memory regions (and thus use of a cheaper memory device and controlling device), or both.

It will be appreciated that where there are more than two memory regions, these can be read from in any desired order. For example, where there are three such memory regions M1, M2, M3, these can be repeatedly read in the order: M1, M2, M3, M1, M2, M3, etc. Alternatively, it may be desirable to read them in a different order, which may be ad hoc and not even repetitive.

Each information cell may have a time period and each memory region may have an access time, the number of memory regions preferably being equal to or greater than the ratio (cell time period/memory region access time) rounded up to the nearest integer. The access time may be the sum of an access burst time and a latency period. In the context of an ATM cell, the cell period may be the cell size (in bits) divided by the link rate (in bits per second).

There may be exactly two said memory regions, alternate information cells in the packet information stream being obtained by alternately reading information cells from said two memory regions.

The plural memory regions may be provided in a single memory device. The memory device may be a SDRAM. Presently available SDRAMs have four internal memory banks, served by a shared bus, and which can be accessed in an interleaved manner. Two or more of those memory banks can be used to store the identical data referred to above.

Each of the plural memory regions may be provided by a respective discrete memory device. The memory devices may be SDRAMs.

According to a second aspect of the present invention, there is provided a traffic generator for generating a packet information stream that comprises plural information cells, the traffic generator comprising: plural memory regions each of which contains in use identical data in the form of plural information cells; at least one memory-reading device constructed and arranged to read information cells from the plural memory regions in an alternating manner such that, as an information cell is being read from one of the memory regions, the next memory region from which the next information cell is to be read can be activated whereby said next information cell can be read from said next memory region substantially as soon as the previous information cell has been read from said one of the memory regions, thereby to generate a packet information stream from said read information cells.

Each information cell may have a time period, each memory region may have an access time, the number of memory regions preferably being equal to or greater than the ratio (cell time period/memory region access time) rounded up to the nearest integer.

There may be exactly two said memory regions, the at least one memory-reading device being constructed and arranged to alternately read information cells from said two memory regions thereby to generate a packet information stream from said read information cells.

The plural memory regions may be provided in a single memory device. The memory device may be a SDRAM.

Each of the plural memory regions may be provided by a respective discrete memory device. The memory devices may be SDRAMs.

According to a third aspect of the present invention, there is provided a method of generating a packet information stream that comprises plural information cells, the method comprising: storing identical data in the form of plural information cells in each of plural memory regions; and, generating a packet information stream by reading groups of information cells from the plural memory regions in an alternating manner such that, as a group of information cells is being read from one of the memory regions, the next memory regions from which the next group of information cells is to be read can be activated whereby said next group of information cells can be read from said next memory region substantially as soon as the previous group of information cells has been read from said one of the memory regions, at least one of the groups of information cells comprising at least two said information cells.

Each group of information cells may have a time period, each memory region may have an access time, the number of memory devices preferably being equal to or greater than the ratio (group of information cells time period/memory region access time) rounded up to the nearest integer.

There may be exactly two said memory regions, alternate groups of information cells in the packet information stream being obtained by alternately reading groups of information cells from said two memory regions.

The plural memory regions may be provided in a single memory device. The memory device may be a SDRAM.

Each of the plural memory regions may be provided by a respective discrete memory device. The memory devices may be SDRAMs.

According to a fourth aspect of the present invention, there is provided a traffic generator for generating a packet information stream that comprises plural information cells, the traffic generator comprising: plural memory regions each of which contains in use identical data in the form of plural information cells; at least one memory-reading device constructed and arranged to read groups of information cells from the plural memory regions in an alternating manner such that, as a group of information cells is being read from one of the memory regions, the next memory region from which the next groups of information cells is to be read can be activated whereby said next group of information cells can be read from said next memory region substantially as soon as the previous group of information cells has been read from said one of the memory regions, thereby to generate a packet information stream from said read group of information cells, at least one of the groups of information cells comprising at least two said information cells.

Each group of information cells may have a time period, each memory region may have an access time, the number of memory regions preferably being equal to or greater than the ratio (group of information cells time period/memory region access time) rounded up to the nearest integer.

There may be exactly two said memory regions, the at least one memory-reading device being constructed and arranged to alternately read groups of information cells from said two memory regions thereby to generate a packet information stream from said read information cells.

The plural memory regions may be provided in a single memory device. The memory device may be a SDRAM.

Each of the plural memory regions may be provided by a respective discrete memory device. The memory devices may be SDRAMs.

According to another aspect of the present invention, there is provided a method of providing random access to stored data, the method comprising: storing identical data in the form of plural data blocks in each of plural memory regions; and, reading said data by reading data blocks from the plural memory regions in an alternating manner such that, as a data block is being read from one of the memory regions, the next memory region from which the next data block is to be read can be activated whereby said next data block can be read from said next memory region substantially as soon as the previous data block has been read from said one of the memory regions.

Each data block may have a time period, each memory region may have an access time, the number of memory regions preferably being equal to or greater than the ratio (data block period/memory region access time) rounded up to the nearest integer.

There may have exactly two said memory regions.

The plural memory regions may be provided in a single memory device. The memory device may be a SDRAM.

Each of the plural memory regions may be provided by a respective discrete memory device. The memory devices may be SDRAMs.

Embodiments of the present invention will now be described by way of example with reference to the accompanying drawings, in which:

FIG. 1 is a schematic representation showing the relationship between a cell period and a SDRAM access time when data is read from a single memory bank of a single SDRAM;

FIG. 2 shows schematically the relationship between cell period and SDRAM access time when data is read from more than one memory bank or SDRAM in accordance with one embodiment of the present invention;

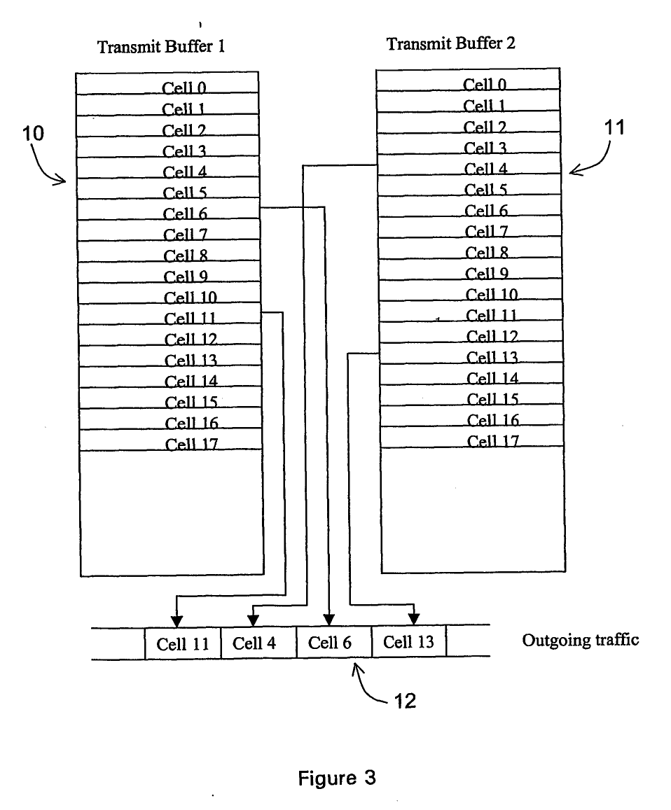

FIG. 3 shows schematically the reading of information cells from plural memory banks or SDRAMs in accordance with one embodiment of the present invention; and,

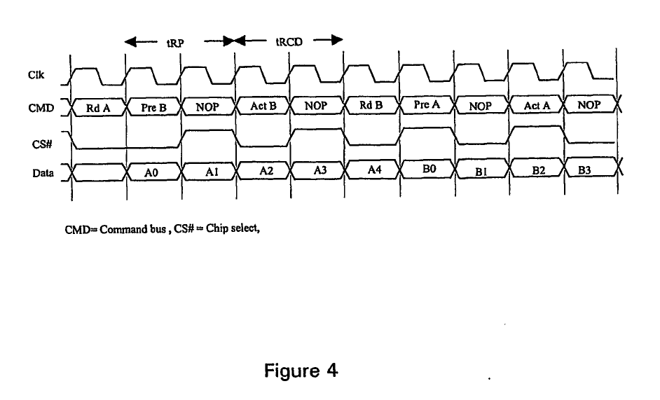

FIG. 4 shows schematically a memory bank interleaving technique with a single SDRAM.

Traffic generators, used for example in ATM test systems, are known per se. Accordingly, the detailed construction and operation of the traffic generator per se will not be further described.

Referring now to FIGS. 2 and 3, in accordance with one embodiment of the present invention a traffic generator has plural memory regions 10, 11. The memory regions 10, 11 may be provided by discrete memory devices. In a preferred embodiment, the memory devices are SDRAMs. Alternatively, the memory regions 10, 11 may be separate memory banks provided within a multi-bank memory device and to which interleaved access is possible. Currently available SDRAMs have four such memory banks. FIG. 4 shows schematically an example of a memory bank interleaving technique with a single SDRAM, the SDRAM command bus being shared but bank B being precharged and activated whilst the burst read from bank A is in progress and vice versa. In any event, identical copies of the data is stored in each memory region 10, 11, whether the memory regions 10, 11 are in different discrete devices or separate memory banks within a single device. In the preferred embodiment, this data is stored in the form of information cells 0, 1, 2, . . .

In order to generate a packet information stream 12 which is to be used in simulating real ATM traffic conditions, in the preferred embodiment a cell is read from one memory region 10, and the next cell is read from the or another memory region 11, and so on. For example, referring to FIG. 3, first cell 11 is read from the first memory region 10; cell 4 is then read from the second memory region 11; cell 6 is then read from the first memory region 10; etc., etc., thereby to generate the packet information stream 12. The effect of reading the information cells in this interleaved manner can be seen from FIG. 2. In particular, whilst data is being read from the first memory region 10 during a first time period t₁, the other memory region 11 is precharged and activated such that at the start of the next time period t₂, the next information cell in the packet information stream 12 can be read immediately from the second memory region 11. During that second time period t₂, the first memory region 11 can itself be precharged and activated, ready for use in reading out the next cell required for the packet information stream 12.

In this example, the number of memory regions containing identical copies of the data depends on the ratio of the access time (including any latency) of the memory region to the cell period. In particular, in this embodiment, the number of memory regions required is equal to the ratio of the memory region access time to the cell period rounded up to the nearest integer. In the particular case of the memory regions being banks of a SDRAM (whether they are plural banks in a single SDRAM or separate banks in separate SDRAMs), the following hold true:
SDRAM access time=SDRAM burst time+SDRAM latency
SDRAM burst time=SDRAM clock period×cell block size/SDRAM bus width
SDRAM latency=row precharge time, tRP+RAS to CAS delay, tRCD
where:

RAS stands for the Row Address Strobe, which is one of the control lines on an SDRAM that is decoded by the SDRAM when a command is issued (Chip select CS activated indicates a command); CAS stands for Column Address Strobe, which is another control line on an SDRAM that is decoded by the SDRAM when a command is issued; and RCD stands for Read/Write Command Delay time. tRCD is a common standard abbreviation and time specification used in SDRAM datasheets and specifies the minimum delay between issuing an Activate command and a subsequent Read or Write Command (hence RAS to CAS delay). It is necessary in practice to round up to an integer number of clock cycles.

The cell period equals cell size/link rate.

For example, for a traffic generator supplying ATM cells on a 2488 Mb/s link from a 32 bit wide PC100 SDRAM buffer clocked at 100 MHz which stores 64 byte cell blocks (53 bytes plus 11 bytes of cell descriptor):
SDRAM Burst time=10×64/4 ns=160 ns
SDRAM Latency=20+20 ns=40 ns
Cell period=53×8/2488×10⁶ s=170 ns
Number of buffers required=(160+40)/170Δ2 buffers required.

The traffic-shaping algorithm determines the actual sequence of cells required for the packet information stream 12. This together with the chosen transmit buffer or memory region format determines the buffer address used for the SDRAM access. As mentioned, the simple example of FIG. 3 shows a dual transmit buffer system in which the transmitted cells are taken strictly alternately from the two buffers.

Use of the present invention in an ATM traffic generator allows higher bandwidth traffic generation than previously even though random access of the transmit buffer memory regions is used (in order to provide for the flexible traffic shaping demanded of a realistic traffic generator). Alternatively, the required bandwidth can be obtained at a lower clock rate for the memory regions, which may allow the use of lower speed-rated devices for the memory and memory controller (which may be for example a FPGA or ASIC), which are in general less expensive.

In the examples given above, individual information cells have been read singly and strictly alternately from the two memory regions 10, 11. It will be appreciated that many benefits of the present invention can be obtained even if for example one or more cells are read as a group from one memory region, with subsequent reading of one or more information cells from the or another memory region. In general, therefore, it can be said that groups of information cells can be read first from one memory region and then from another memory region, before reverting to the first or yet another memory region; where in general a “group” of information cells may consist of one or more information cells.

Moreover, where there are more than two memory regions in which identical data is saved, in general these can be accessed in any order and for example need not be in a strictly repetitive cyclical order (of M1, M2, M3, M1, M2, M3, etc. where Mn is a memory region).

It will be appreciated that the storing of identical data in the form of plural data blocks in each of plural memory regions, and the reading of the data by reading data blocks from the plural memory regions in an alternating manner generally as described above, can be used to significant advantage in any application where speed of read access is important and, particularly, where the blocks of data are accessed in a random manner.

Embodiments of the present invention have been described with particular reference to the examples illustrated. However, it will be appreciated that variations and modifications may be made to the examples described within the scope of the present invention.

1. A method of generating a packet information stream that comprises plural information cells, the method comprising:
storing identical data in the form of plural information cells in each of plural memory regions; and,
generating a packet information stream by reading information cells from the plural memory regions in an alternating manner such that, as an information cell is being read from one of the memory regions, the next memory region from which the next information cell is to be read can be activated whereby said next information cell can be read from said next memory region substantially as soon as the previous information cell has been read from said one of the memory regions.

2. A method according to claim 1, wherein each information cell has a time period, each memory region has an access time, and the number of memory regions is equal to or greater than the ratio (cell time period/memory region access time) rounded up to the nearest integer.

3. A method according to claim 1, wherein there are exactly two said memory regions, alternate information cells in the packet information stream being obtained by alternately reading information cells from said two memory regions.

4. A method according to claim 1, wherein the plural memory regions are provided in a single memory device.

5. A method according to claim 4, wherein the memory device is a SDRAM.

6. A method according to claim 1, wherein each of the plural memory regions is provided by a respective discrete memory device.

7. A method according to claim 6, wherein the memory devices are SDRAMs.

8. A traffic generator for generating a packet information stream that comprises plural information cells, the traffic generator comprising:
plural memory regions each of which contains in use identical data in the form of plural information cells;
at least one memory-reading device constructed and arranged to read information cells from the plural memory regions in an alternating manner such that, as an information cell is being read from one of the memory regions, the next memory region from which the next information cell is to be read can be activated whereby said next information cell can be read from said next memory region substantially as soon as the previous information cell has been read from said one of the memory regions, thereby to generate a packet information stream from said read information cells.

9. A traffic generator according to claim 8, wherein each information cell has a time period, each memory region has an access time, and the number of memory regions is equal to or greater than the ratio (cell time period/memory region access time) rounded up to the nearest integer.

10. A traffic generator according to claim 8, wherein there are exactly two said memory regions, the at least one memory-reading device being constructed and arranged to alternately read information cells from said two memory regions thereby to generate a packet information stream from said read information cells.

11. A traffic generator according to claim 8, wherein the plural memory regions are provided in a single memory device.

12. A traffic generator according to claim 11, wherein the memory device is a SDRAM.

13. A traffic generator according to claim 8, wherein each of the plural memory regions is provided by a respective discrete memory device.

14. A traffic generator according to claim 13, wherein the memory devices are SDRAMs.

15. A method of generating a packet information stream that comprises plural information cells, the method comprising:
storing identical data in the form of plural information cells in each of plural memory regions; and,
generating a packet information stream by reading groups of information cells from the plural memory regions in an alternating manner such that, as a group of information cells is being read from one of the memory regions, the next memory regions from which the next group of information cells is to be read can be activated whereby said next group of information cells can be read from said next memory region substantially as soon as the previous group of information cells has been read from said one of the memory regions, at least one of the groups of information cells comprising at least two said information cells.

16. A method according to claim 15, wherein each group of information cells has a time period, each memory region has an access time, and the number of memory devices is equal to or greater than the ratio (group of information cells time period/memory region access time) rounded up to the nearest integer.

17. A method according to claim 15, wherein there are exactly two said memory regions, alternate groups of information cells in the packet information stream being obtained by alternately reading groups of information cells from said two memory regions.

18. A method according to claim 15, wherein the plural memory regions are provided in a single memory device.

19. A method according to claim 18, wherein the memory device is a SDRAM.

20. A method according to claim 15, wherein each of the plural memory regions is provided by a respective discrete memory device.

21. A method according to claim 20, wherein the memory devices are SDRAMs.

22. A traffic generator for generating a packet information stream that comprises plural information cells, the traffic generator comprising:
plural memory regions each of which contains in use identical data in the form of plural information cells;
at least one memory-reading device constructed and arranged to read groups of information cells from the plural memory regions in an alternating manner such that, as a group of information cells is being read from one of the memory regions, the next memory region from which the next group of information cells is to be read can be activated whereby said next group of information cells can be read from said next memory region substantially as soon as the previous group of information cells has been read from said one of the memory regions, thereby to generate a packet information stream from said read group of information cells, at least one of the groups of information cells comprising at least two said information cells.

23. A traffic generator according to claim 22, wherein each group of information cells has a time period, each memory region has an access time, and the number of memory regions is equal to or greater than the ratio (group of information cells time period/memory region access time) rounded up to the nearest integer.

24. A traffic generator according to claim 22, wherein there are exactly two said memory regions, the at least one memory-reading device being constructed and arranged to alternately read groups of information cells from said two memory regions thereby to generate a packet information stream from said read information cells.

25. A traffic generator according to claim 22, wherein the plural memory regions are provided in a single memory device.

26. A traffic generator according to claim 25, wherein the memory device is a SDRAM.

27. A traffic generator according to claim 22, wherein each of the plural memory regions is provided by a respective discrete memory device.

28. A traffic generator according to claim 27, wherein the memory devices are SDRAMs.

29. A method of providing random access to stored data, the method comprising:
storing identical data in the form of plural data blocks in each of plural memory regions; and,
reading said data by reading data blocks from the plural memory regions in an alternating manner such that, as a data block is being read from one of the memory regions, the next memory region from which the next data block is to be read can be activated whereby said next data block can be read from said next memory region substantially as soon as the previous data block has been read from said one of the memory regions.

30. A method according to claim 29, wherein each data block has a time period, each memory region has an access time, and the number of memory regions is equal to or greater than the ratio (data block period/memory region access time) rounded up to the nearest integer.

31. A method according to claim 29, wherein there are exactly two said memory regions.

32. A method according to claim 29, wherein the plural memory regions are provided in a single memory device.

33. A method according to claim 32, wherein the memory device is a SDRAM.

34. A method according to claim 29, wherein each of the plural memory regions is provided by a respective discrete memory device.

35. A method according to claim 34, wherein the memory devices are SDRAMs.
